(19) United States
(12) Patent Application Publication
(10) Pub. No.: US 2009/0225736 A1
(43) Pub. Date: Sep. 10, 2009

(54) BRIDGING BETWEEN A MOBILE CELLULAR TELEPHONE NETWORK AND A DATA, VOICE OVER INTERNET PROTOCOL (VOIP) NETWORK

(76) Inventor: Pinhas PATARKAZISHVILI, Tel Aviv (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/467,280

(22) Filed: May 17, 2009

Related U.S. Application Data
(63) Continuation of application No. PCT/IL2007/001478, filed on Nov. 29, 2007.
(60) Provisional application No. 60/867,826, filed on Nov. 30, 2006.

(51) Int. Cl. H04W 4/00; H04M 1/66

(52) U.S. Cl. 370/338; 455/411

(57) ABSTRACT

A method for providing telephone communications in a system including a wide area data network and a wireless cellular mobile telephone network. A local cellular mobile telephone operator serves the wireless cellular mobile telephone network by providing a radio communications interface within a local region. The local cellular mobile telephone operator issues a subscriber identity module (SIM) to a user of the wireless cellular mobile telephone network. A communications terminal interfaces to the wide area data network using a radio interface to a base transceiver station (BTS) of the wireless cellular mobile telephone network within the local region. The communications terminal includes a communications module for handling a telephone communication through the wide area data network and the wireless cellular mobile telephone network. The communications terminal includes a subscriber identity module (SIM) emulator. A client computer is attached to the wide area data network at a remote site outside the local region. The client computer includes a subscriber identity module (SIM) reader. Telephone communications are provided by (a) inserting the SIM card into the SIM reader (b) transferring SIM identification data of the SIM card to the terminal over the wide area data network and (c) emulating the SIM card based on the SIM identification data. The emulation is performed by the emulator at the communications terminal. The SIM data is provided to the wireless cellular mobile telephone network operator within the local region over the radio communications interface.

### FIELD AND BACKGROUND OF THE INVENTION

The present invention relates to telephony and, more particularly to bridging a wide area data network with a mobile cellular telephone network.

Reference is made to of FIG. 1 including a cellular telephone network, e.g GSM. In the mobile cellular telephone network, individual cells of the mobile network are served by geographically spaced terrestrial base station subsystems (BSS). Each BSS includes one or more radio transceiver stations (BTS) which are coupled through base station controllers (BSC) to a mobile switching center (MSC), which typically provides a gateway out of the cellular telephone network to a conventional public switched telephone network (PSTN) with signaling protocols provided by Signaling System #7 (SS7). The cellular telephone network includes a home location register (HLR) which stores information about the subscribers to the system and their mobile stations, i.e. cellular telephones. When a mobile station (MS) is switched on, the mobile station registers with the HLR and an authentication procedure is carried out. Visitor Location Register (VLR) is a database which stores information about all the mobile stations that are currently under the jurisdiction of the MSC (Mobile Switching Center) which it serves. The VLR stores the current LAI (Location Area Identity) of the MS. LAI identifies under which BSC (Base Station Controller) the MS is currently present.

Whenever an MSC detects a new MS in its network, in addition to creating a new record in the VLR, it also updates the HLR of the mobile subscriber, apprising it of the new location of that MS.

GSM authentication aims to protect the GSM network against unauthorized access and to protect users' privacy. Each MS is provided with a smart card known as a subscriber identification module (SIM) which stores two unique identifiers to identify the subscriber. The first identifier includes an international mobile subscriber identity (IMSI) and the second identifier includes a secret parameter referred to in the GSM specification as Ki. Associated with the HLR is an authentication center (AuC, not shown in FIG. 1) which includes data corresponding to the IMSI and Ki for each subscriber to the network.

When the mobile station is switched on, and at other times, the IMSI is transmitted from the mobile station to the HLR, which then refers to the AuC to authenticate the user. To enhance security, an agreed identity alias, known as TMSI (Temporary Mobile Subscriber Identity) is transmitted instead of the IMSI wherever possible, for example where the TMSI has been agreed between the network and an identified subscriber in a previously encrypted message. The IMSI is checked in the memory of the AuC, and a corresponding value of Ki is retrieved, A 128 bit random number RAND is also generated in the AuC. The random number RAND and the value of Ki are applied as inputs to an algorithm referred to in the GSM Specifications as A3, to generate a 32 bit signed result SRES. A3 is an operator-dependent one-way function, so that the generation of SRES is computationally easy, while the calculation of Ki knowing RAND and SRES is computationally difficult, if not impossible. The AuC also includes an algorithm referred to in the GSM Specifications as A8, also an operator-dependent function, which generates a secret key Kc, agreed between the mobile station and the network, that is used in the process of encryption/decryption of data transmitted over the air between the mobile station and the network. In practice, the majority of GSM operators implement the A3 and A8 algorithms as a single algorithm referred to as A3/A8, which produces a 128 bit output of which 32 bits constitute SRES and 64 bits constitute Kc, with the remaining 32 bits being currently unused.

GSM supports up to seven data encryption algorithms. Each of these algorithms uses as its inputs the secret key Kc and the frame number of data transmitted through the network.

A triplet of signals comprising RAND, SRES and Kc is fed from the AuC, through the HLR to the MSC, which acts as a checking station in the authentication procedure. The individual value of RAND is then transmitted on to the mobile station through the network from the MSC. The SIM of the mobile station has the algorithm A3/A8 stored locally, so that it can perform the same calculation as is carried out at the AuC to generate a corresponding value of SRES, referred to herein as SRES′, and Kc at the mobile station, using the received value of RAND and the value of Ki stored in the SIM.

SRES′ is transmitted back through the network to the MSC and compared with SRES. If they are the same, the mobile station is authenticated, otherwise registration of the mobile station with the HLR is barred. If the mobile station is authenticated, the MSC then negotiates with the mobile station to determine an encryption algorithm common to both. This involves the MSC comparing encryption algorithms supported by the network with those supported by the mobile station to ensure that both the mobile station and the network have access to the same algorithm for the purpose of data encryption/decryption. For example, having confirmed that both MSC and MS can use the algorithm A5/1, the MSC initiates encryption/decryption of data transmitted over the network using the A5/1 algorithm. The SIM of the mobile station generates its own value of the secret key Kc using its locally stored copy of the algorithm A8. The local value of Kc at the mobile station can then be used to encrypt data transmitted by it and decrypt data received from the BTS, also using the locally held copy of the A5/1 algorithm.

The authentication procedure used in GSM has the advantage that only random numbers are transmitted over the air interface between the mobile station and the BTS, which minimizes the risk of fraudulent registration.

If the mobile station roams to a different GSM network, in a different geographical location, the mobile station registers with the visitor location register (VLR) of the visited network, which communicates with the HLR of the home network for authentication, billing and other purposes.

The Session Initiation Protocol (SIP) is an application-layer control (signaling) protocol for creating, modifying, and terminating sessions with one or more participants. SIP is used to create two-party, multiparty, or multicast sessions that include Internet telephone calls, multimedia distribution, and multimedia conferences. SIP is designed to be independent of the underlying transport layer and can run on transmission control protocol (TCP), user datagram protocol (UDP), or Stream Control Transmission Protocol (SCTP). The latest version of the specification is RFC 3261 from the IETF SIP Working Group. SIP is used as a signaling protocol for Voice over IP, along with H.323 and others. {http://en.wikipedia.org/wiki/Session_Initiation_Protocol}

The Real-time Transport Protocol (or RTP) defines a standardized packet format for delivering audio and video over the Internet. RTP was developed by the Audio-Video Transport Working Group of the IETF and first published in 1996 as RFC 1889 which was made obsolete in 2003 by RFC 3550. Real time transport protocol can also be used in conjunction with RSVP protocol which enhances the field of multimedia applications.

RTP does not have a standard TCP or User Datagram Protocol (UDP) port on which it communicates. The only standard that RTP obeys is that UDP communications are done via an even port and the next higher odd port is used for RTP Control Protocol (RTCP) communications. Although there are no standards assigned, RTP is generally configured to use ports 16384-32767. RTP can carry any data with real-time characteristics, such as interactive audio and video. Call setup and tear-down for VoIP (Voice over Internet Protocol) applications is usually performed by either SIP or H.323 protocols.

RTP was originally designed as a multicast protocol, but has since been applied in many unicast applications. RTP is frequently used in streaming media systems (in conjunction with RTSP) as well as videoconferencing and push to talk systems (in conjunction with H.323 or SIP), making it the technical foundation of the Voice over IP industry. RTP goes along with the RTCP and it's built on top of the User Datagram Protocol (UDP). Applications using RTP are less sensitive to packet loss, but typically very sensitive to delays, so UDP is a better choice than TCP for such applications. {http://en.wikipedia.org/wiki/Real-time_Transport_Protocol}

### SUMMARY OF THE INVENTION

The term “subscriber identification module (SIM)” as used herein refers to either SIM as specified by GSM or the equivalent in other cellular standards. For instance, the equivalent of a SIM in UMTS is called the Universal Subscriber Identity Module (USIM), and Removable User Identity Module (RUIM) in CDMA devices.

The term “local” as used herein refers to a cell in a cellular telephone network in a region from which a SIM is issued and the user of a cellular telephone does not pay extra roaming charges when placing a call. The term “remote” as used herein includes cells which are not local, from which the user does pay roaming charges when placing a telephone call.

According to the present invention there is provided a system including a wide area data network and a wireless cellular mobile telephone network. A local cellular mobile telephone operator serves the wireless cellular mobile telephone network within a local region. The local cellular mobile telephone operator issues a subscriber identity module (SIM) to a user of the wireless cellular mobile telephone network. A communications terminal interfaces to the wide area data network using a radio interface to a base transceiver station of the wireless cellular mobile telephone network within the local region. The terminal includes a communications module for handling a telephone communication through the wide area data network and the wireless cellular mobile telephone network. The communications terminal includes a subscriber identity module (SIM) emulator. A client computer is attached to the wide area data network at a remote site. The remote site is outside the local region. The client computer includes a subscriber identity module (SIM) reader. A user of the client computer inserts the SIM card into the SIM reader. The SIM identification data of the SIM card is transferred to the communications terminal over the wide area data network. The SIM emulator provides the SIM data to the wireless cellular mobile telephone network within the local region. A server is preferably attached to the wide area data network preferably including a SIM server and a session initiation protocol (SIP) server mediates data transfer between the client computer and the communications module for authentication of the SIM identification data and registration of the SIM card. The SIM server and the session initiation protocol (SIP) server preferably mediate initiation of the telephone communication through the wide area data network; the telephone communication being between the client computer and the communications module of the communications terminal. After the initiation of the telephone communication, bi-directional data streams of the telephone communication are preferably transferred between the communications terminal and the client computer but not through the server. The system preferably includes an authentication mechanism whereby authentication information is passed from the client computer to the communications terminal. The authentication information is required for authenticating the SIM module by the local cellular mobile telephone operator.

According to the present invention there is provided a method for providing telephone communications in a system including a wide area data network and a wireless cellular mobile telephone network. A local cellular mobile telephone operator serves the wireless cellular mobile telephone network by providing a radio communications interface within a local region. The local cellular mobile telephone operator issues a subscriber identity module (SIM) to a user of the wireless cellular mobile telephone network. A communications terminal interfaces to the wide area data network using a radio interface to a base transceiver station (BTS) of the wireless cellular mobile telephone network within the local region. The communications terminal includes a communications module for handling a telephone communication through the wide area data network and the wireless cellular mobile telephone network. The communications terminal includes a subscriber identity module (SIM) emulator. A client computer is attached to the wide area data network at a remote site outside the local region. The client computer includes a subscriber identity module (SIM) reader. Telephone communications are provided by (a) inserting the SIM card into the SIM reader (b) transferring SIM identification data of the SIM card to the terminal over the wide area data network and (c) emulating the SIM card based on the SIM identification data. The emulation is performed by the emulator at the communications terminal. The SIM data is provided to the wireless cellular mobile telephone network operator within the local region over the radio communications interface. Authentication information is preferably transferred between the client computer and the terminal. The authentication information is required for authenticating the SIM module by the local cellular mobile telephone operator. A server is preferably attached to the wide area data network preferably including a SIM server and a session initiation protocol (SIP) server mediates data transfer between the client computer and the communications module for authentication of the SIM identification data and registration of the SIM card. The SIM server and the session initiation protocol (SIP) server preferably mediate initiation of the telephone communication through the wide area data network. The telephone communication being between the client computer and the communications module of the communications terminal. After the initiation of the telephone communication, bi-directional data streams of the telephone communication are preferably transferred between the communications terminal and the client computer but not through the server.

### BRIEF DESCRIPTION OF THE DRAWINGS

The present invention is herein described, by way of example only, with reference to the accompanying drawings, wherein like reference numbers are used throughout respectively for the same elements or steps and certain elements are referenced by their well known acronyms without reference numbers.

FIG. 1 is a prior art block diagram of a conventional telephone network including a GSM network and public switched telephone network. (PSTN);

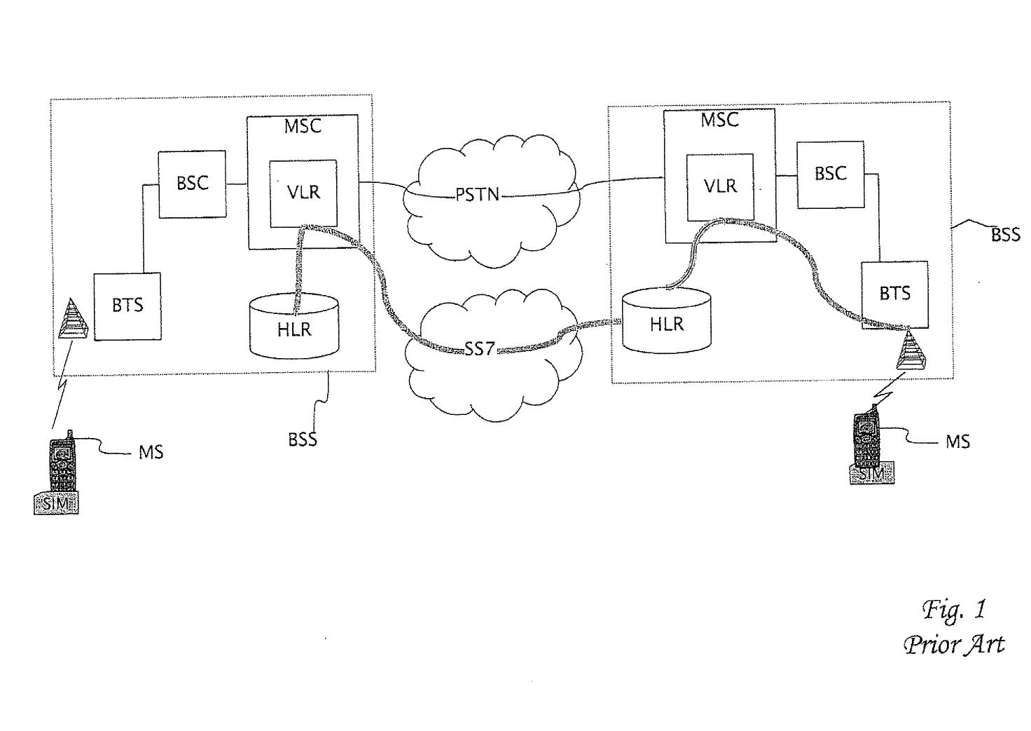

FIG. 2 illustrates a top-level view of an embodiment of the present invention including a server, a client computer and a terminal;

FIG. 3 is simplified flow diagram of a method, according to an embodiment of the present invention;

FIG. 4 is a simplified block diagram, illustrating in more detail the server, the client computer and the terminal, according to an embodiment of the present invention;

FIG. 5 illustrates in further detail of the server, according to an embodiment of the present invention;

FIG. 6 is a flow diagram of SIM data transfer and authentication during registration of the client computer, according to an embodiment of the present invention; and

FIG. 7 is a flow diagram of authentication while placing an outgoing call from the client computer.

### DESCRIPTION OF THE PREFERRED EMBODIMENTS

The present invention is of a system and method for bridging between a mobile cellular telephone network and a data, e.g voice over Internet protocol (VoIP) network. Specifically, the system and method include a computerized communications terminal which communicates over the radio frequency (RF) interface of the cellular telephone network. The computerized communications terminal relays SIM data and authentication data between the mobile cellular telephone network and a client computer at a remote location through the data network. The client computer is preferably equipped with a SIM card and a softphone. The user of the client computer is preferably billed for cellular telephone services by his local cellular telephone service provider at local billing rates and the user saves on roaming charges.

The principles and operation of a system and method of bridging between a mobile cellular telephone network and a data, e.g voice over Internet protocol network, according to embodiments of the present invention, may be better understood with reference to the drawings and the accompanying description.

By way of introduction, embodiments of the present invention are intended to provide a system and method for making and receiving telephone calls while traveling or roaming away from home. The system and method avoid high roaming rates of cellular telephone networks. The roamer typically inserts a SIM card into his/her personal computer/laptop at the remote location. A server or soft switch attached to the Internet, registers the user. A locally installed computer or communications terminal is connected by the cellular radio frequency (RF) interface to the home cellular telephone network. Once login is completed the roaming user can receive and place telephone calls through an Internet connection but only locally through the home region the cellular telephone network. All mobile services are preferably available including voice mail access, SMS send and receive and feature control.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

It should be noted, that although the discussion is described herein in terms of GSM net-works, the present invention is equivalently applicable to other mobile and/or cellular networks including other standards and technologies including but limited to: CDMA, TDMA, iDEN, D-AMPS, IS-95/cdmaOne, PDC, WiDEN, CDMA2000, W-CDMA, UMTS (3GSM), TD-CDMA/UMTS-TDD, TD-SCDMA, HSDPA, HSUPA, and HSOPA.

The embodiments of the present invention may comprise a general-purpose or special-purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “data network” is defined as any architecture where two or more computer systems may exchange data. Exchanged data may be in the form of electrical signals that are meaningful to the two or more computer systems. When data is transferred or provided over a network or another communications connection (either hardwired, wireless, or a combination of hardwired or wireless) to a computer system or computer device, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions.

In this description and in the following claims, a “computer” or “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone or Personal Digital Assistant “PDA”) where internal modules (such as a memory and processor) work together to perform operations on electronic data.

Those skilled in the art will appreciate that the invention may be practiced in network computing environments with many types of computer system configurations, including mobile telephones, PDA's, pagers, hand-held devices, laptop computers, personal computers, multi-processor systems, microprocessor-based or programmable consumer electronics, network PCs, minicomputers, mainframe computers, and the like. The invention may also be practiced in distributed computing environments where local and remote computer systems, which are linked (either by hardwired links, wireless links, or by a combination of hardwired or wireless links) through a communication network, both perform tasks. In a distributed computing environment, program modules may be located in both local and remote memory storage devices.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

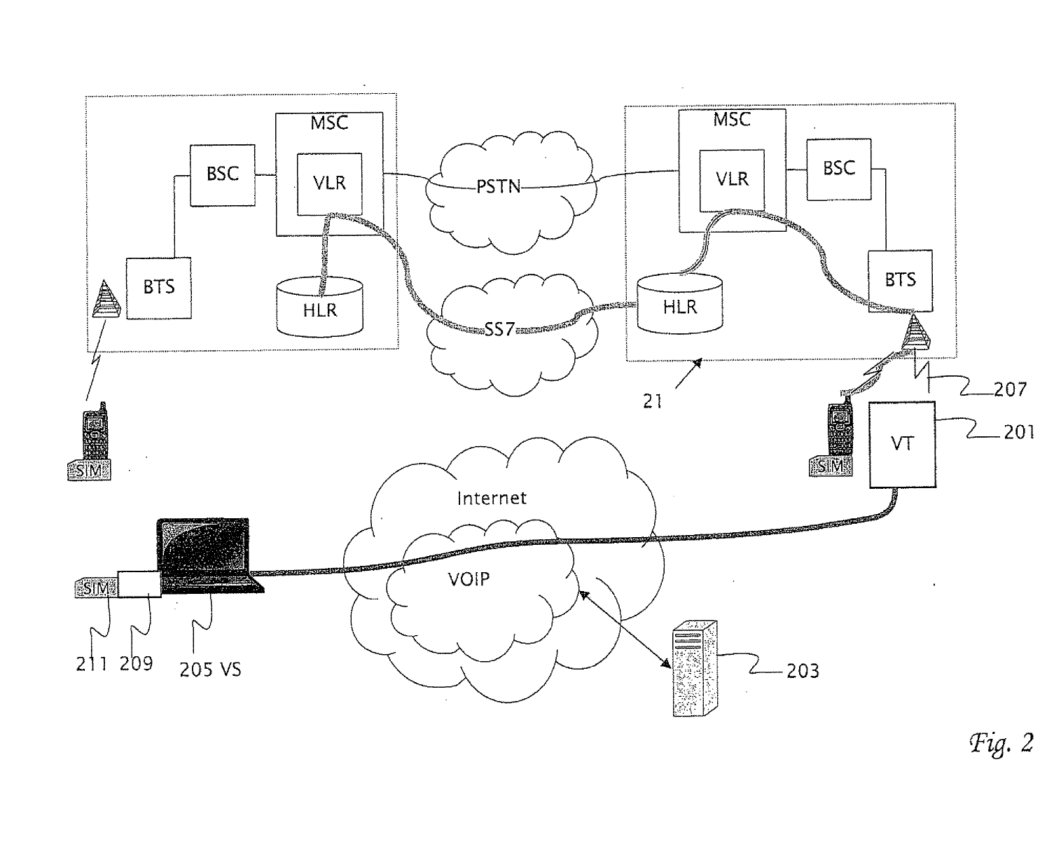

Referring now to the drawings, FIG. 2 illustrates a top-level view of an embodiment of the present invention. A client computer 205 is connected to the Internet. Client computer 205 is equipped with a SIM reader 209. The user of client computer 205 typically owns a SIM card 211 issued by a cellular telephone service provider in his/her home region. A terminal 201 includes a radio interface 207 to a local base transceiver station (BTS) in a cell 21 of a home or local region. A server 203 attached to the data network is used to connect client computer 205 with terminal 201 and to perform various tasks including registering new users, call routing, billing and transferring authentication information.

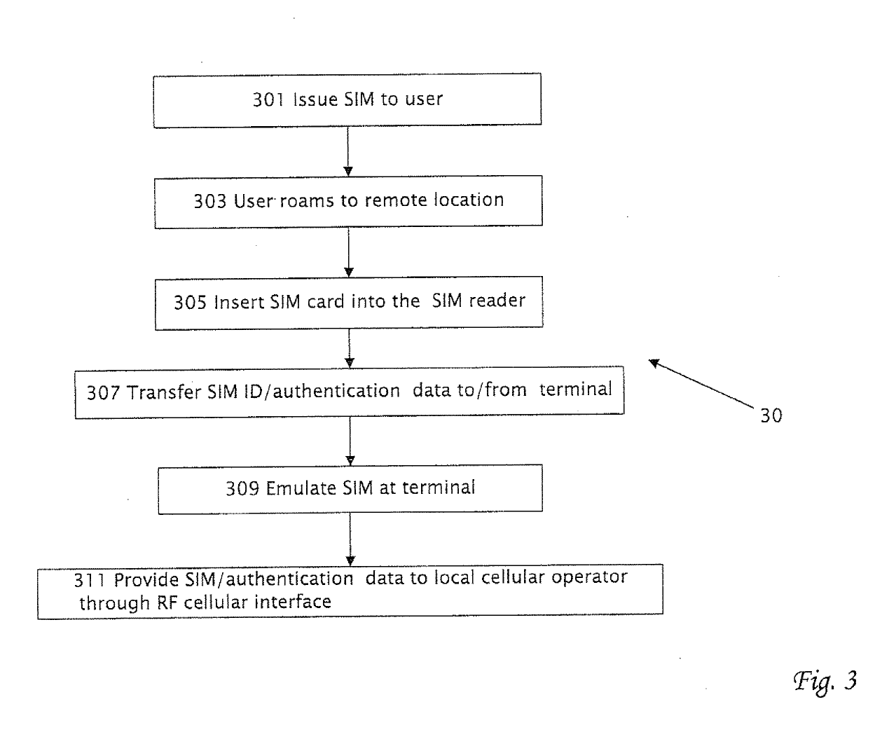

Reference is now made to FIG. 3, a simplified flow diagram 30 of a method, according to an embodiment of the present invention. A mobile cellular telephone service provider issues (step 301) SIM card 211 in a local region. Typically, billing rates in the local region are less than billing rates when telephone calls a placed from outside the local region, i.e. from a remote region. User 303 roams (step 303) to a remote location or region. User inserts (step 305) SIM card 211 into SIM reader 209 at the remote location. SIM identification information/authentication is transferred (step 307) to/from terminal 201. Using the SIM identification information, terminal 201 emulates (step 309) SIM card 211 in the local region. Terminal 201 provides (step 311) the required authentication information to the local cellular operator by relaying the information from SIM card 211 and client computer 205.

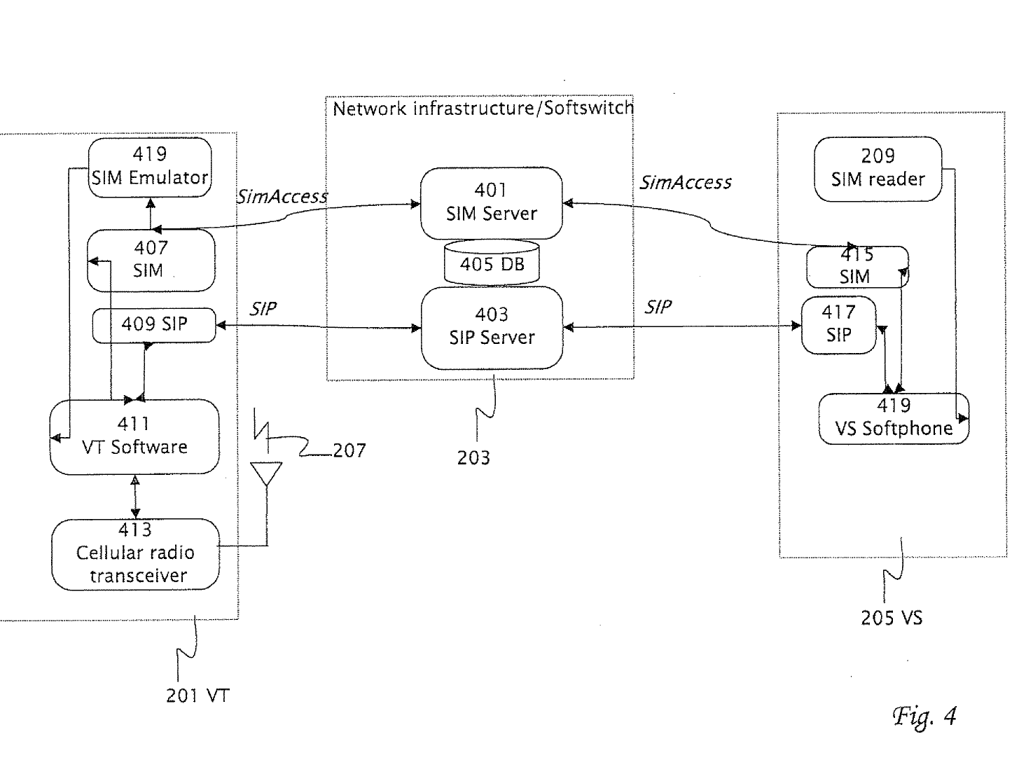

Reference is now made to FIG. 4 which includes a simplified block diagram, according to an embodiment of the present invention. Client computer 205, server 203 and terminal 201 communicate preferably using SIP for call signaling, preferably using a SIP interface 417 in client computer 205, a SIP server 403 in server 203 and a SIP interface 409 in terminal 401. Alternative to SIP, any other VoIP protocol is optionally used for call signaling. A second protocol is preferably used for transfer of SIM data and SIM commands between SIM interface 415 in client computer 205, SIM server 401 in server 203 and SIM interface 407 in terminal 201. A SIM emulator 419 receives SIM information from SIM reader 209. Client computer 205 includes a software telephone 419 which enables the user to place a telephone call. At terminal 201, VT software 411 receives SIM information and call signaling and connects to the local cellular telephone network using a cellular radio (mobile station) transceiver 413.

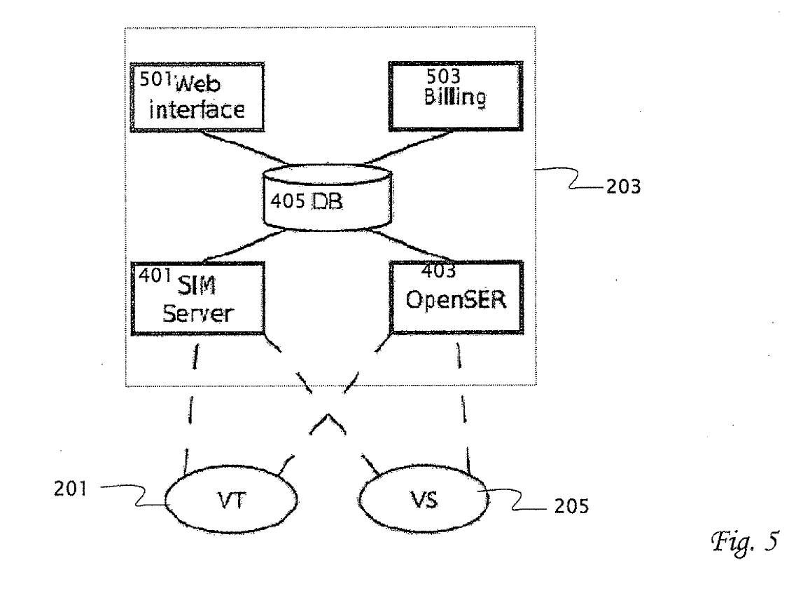

Reference is now also made to FIG. 5 which illustrates in more detail a simplified block diagram of server 203, according to an embodiment of the present invention. A primary function of server 203 is to perform call routing between client computer 205 and terminal 201. Server 203 maintains in storage 405 information the location of terminal 201 for each registered user and user presence whether the user is logged into the telephone service. A billing module 503 records a call data record (CDR) in storage 405 for each call placed. Billing module 503 generates customer call log and billing reports, preferably according to previously determined call rates.

Server 203 routes incoming and outgoing calls, preferably both in the data network, IP-to-IP and to/from the cellular telephone network between terminal 201 and client computer 205. Management is preferably provided over an Internet management interface 501 which provides user account management including: enrolling new users to the system, adding users, deleting users, changing user account information, changing user account status, disallowing outgoing calls, or disallowing both incoming and outgoing calls requiring user action. Other services are optionally offered including a phonebook, instant messages and short message service (SMS)

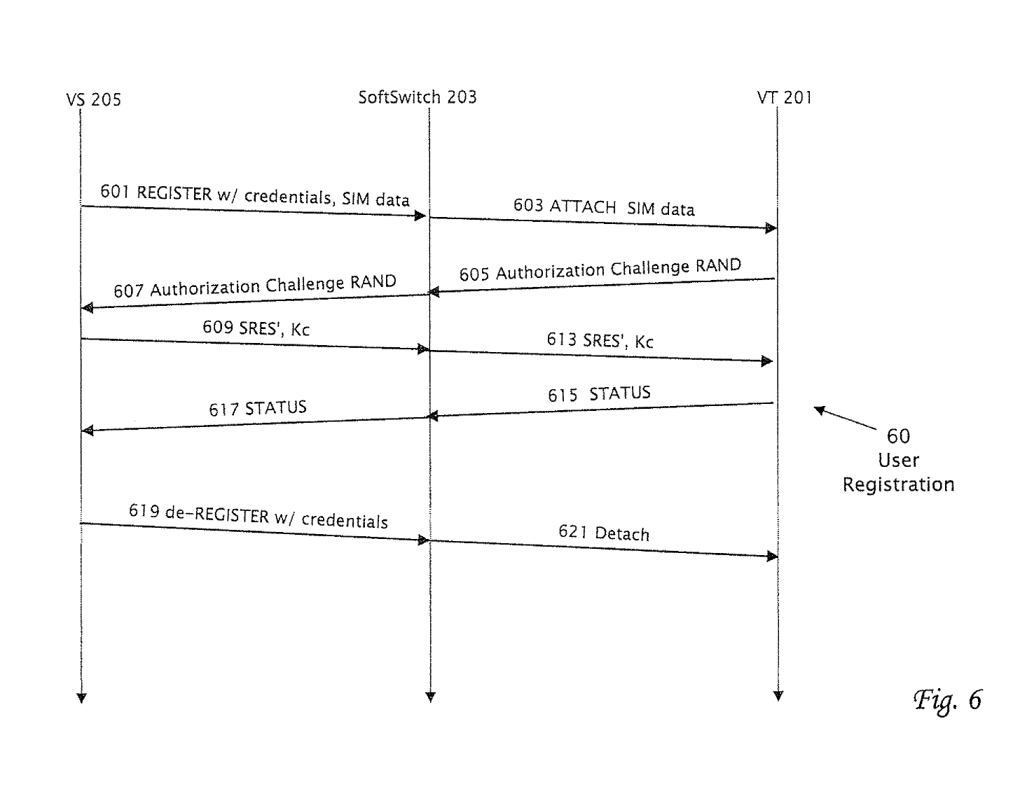

Reference now is made to FIG. 6, a flow diagram of SIM data transfer and authentication during registration of client computer 205. Typically after SIM card 211 is inserted (step 305), client computer 205 requests registration (step 601) with the telephone service. Softswitch 203 receives (step 601) registration request and in response sends (step 603) an ATTACH request to terminal 201 with SIM identification data corresponding to SIM card 211. Terminal 201 transmits (not shown) the ATTACH request to the local base transceiver station (BTS) over the cellular RF interface. Terminal 201 receives (not shown) from the BTS in response an authorization challenge RAND which is transmitted (step 605) to server 203. Server 203 transfers (step 607) the authorization challenge over the data network (Internet) to client computer 205. SIM card 211 sharing encryption algorithm of its home cellular network, calculates SRES′ and Kc and transfers (step 609) the results to server 203, which in turn routes (step 613) the results to terminal 201. Status (e.g. registration successful) of the registration is received (not shown) over the radio interface from the local cell of the cellular telephone network by terminal 201 and the status is transferred (step 615) to server 203. Server 203 routes (step 617) status to client computer 205. Assuming status message includes a successful registration, a user of client computer 205 may use softphone 419 (FIG. 4) to place a telephone call. A deregistration request (step 619) to server 203, causes server 203 transmit a detach request (step 621) to terminal 201, thereby disabling the service

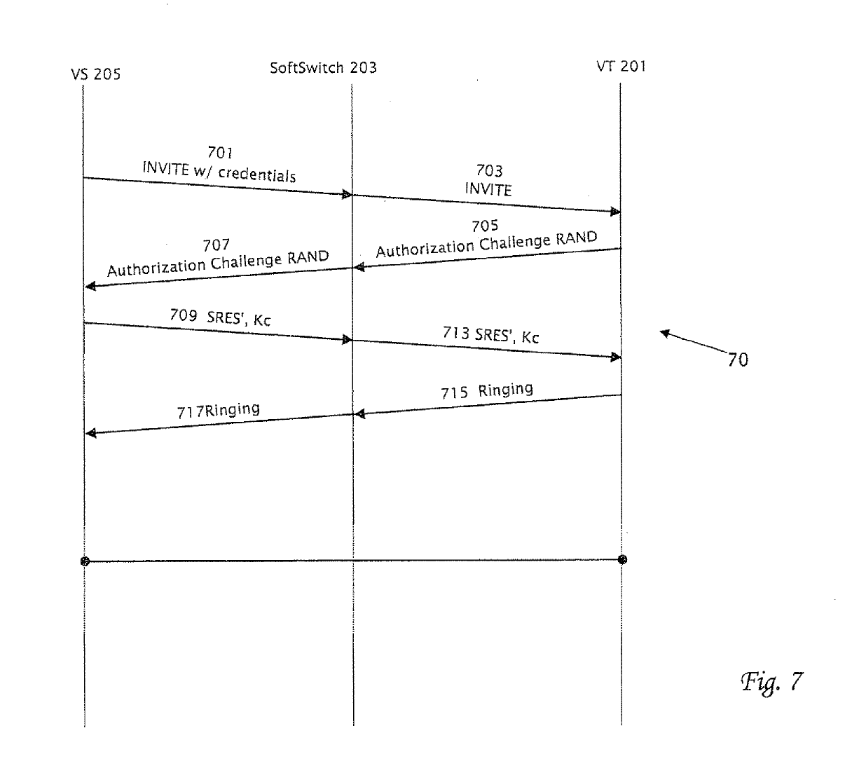

Reference is now made to FIG. 7, a flow diagram 70 of authentication while placing an outgoing call from client computer 205, according to an embodiment of the present invention. An outgoing call is placed at client computer 205, and an INVITE with SIM information is transferred (step 701) to server 203. Server 203 relays (step 703) the INVITE to terminal 201. Terminal 201 receives (not shown) from the BTS in response an authorization challenge RAND which is transmitted (step 705) to server 203. Server 203 transfers (step 707) the authorization challenge over the data network (Internet) to client computer 205. SIM card 211 sharing encryption algorithm of its home cellular network, calculates SRES′ and Kc and transfers (step 709) the results to server 203, which in turn routes (step 713) the results to terminal 201. Ringing is received (not shown) over the radio interface from the local cell of the cellular telephone network by terminal 201 and the ringing status is transferred (step 715) to server 203. Server 203 relays (step 717) status to client computer 205. RTP bi-directional data streams between terminal 201 and client computer 205 are preferably routed (step 723) directly between terminal 201 and client computer 205 and not through server 203.

While the invention has been described with respect to a limited number of embodiments, it will be appreciated that many variations, modifications and other applications of the invention may be made.

1. In a system including a wide area data network and a wireless cellular mobile telephone network, wherein a local cellular mobile telephone operator serves the wireless cellular mobile telephone network within a local region, wherein the local cellular mobile telephone operator issues a subscriber identity module (SIM) to a user of the wireless cellular mobile telephone network, the system comprising:
(a) a communications terminal which interfaces to the wide area data network using a radio interface to a base transceiver station of the wireless cellular mobile telephone network within the local region, wherein said terminal includes a communications module for handling a telephone communication through the wide area data network and the wireless cellular mobile telephone network, and wherein said communications terminal includes a subscriber identity module (SIM) emulator, wherein said communications terminal operationally connects to the wireless cellular mobile telephone network solely through said base transceiver station via said radio interface without direct connection to the wireless cellular mobile telephone network; and
(b) a client computer operatively attached to the wide area data network at a remote site, wherein said client computer includes a subscriber identity module (SIM) reader; wherein the remote site is outside the local region;
wherein a user of said client computer inserts said SIM card into said SIM reader, wherein SIM authentication data of said SIM card is transferred to said communications terminal over the wide area data network, and wherein said SIM emulator provides said SIM authentication data to the wireless cellular mobile telephone network within the local region.

2. The system according to claim 1, further comprising:
(c) a server operatively attached to the wide area data network, said server including a SIM server and a session initiation protocol (SIP) server which mediate data transfer between said client computer and said communications module for authentication of said SIM authentication data and registration of said SIM card.

3. The system according to claim 1, further comprising:
(c) a server operatively attached to the wide area data network, said server including a SIM server and a session initiation protocol (SIP) server which mediate initiation of said telephone communication through the wide area data network, said telephone communications between said client computer and said communications module of said communications terminal.

4. The system according to claim 3, wherein after said initiation of said telephone communication, bi-directional data streams of said telephone communication are transferred between said communications terminal and said client computer but not through said server.

5. The system according to claim 1, further comprising:
(d) an authentication mechanism whereby said SIM authentication data is passed from said client computer to said communications terminal, wherein said SIM authentication data is required for authenticating said SIM module by the local cellular mobile telephone operator.

6. In a system including a wide area data network and a wireless cellular mobile telephone network, wherein a local cellular mobile telephone operator serves the wireless cellular mobile telephone network by providing a radio communications interface within a local region, wherein the local cellular mobile telephone operator issues a subscriber identity module (SIM) to a user of the wireless cellular mobile telephone network, the system including a communications terminal which interfaces to the wide area data network using a radio interface to a base transceiver station (BTS) of the wireless cellular mobile telephone network within the local region, wherein said communications terminal includes a communications module for handling a telephone communication through the wide area data network and the wireless cellular mobile telephone network, and wherein said communications terminal includes a subscriber identity module (SIM) emulator, wherein said communications terminal operationally connects to the wireless cellular mobile telephone network solely through said base transceiver station via said radio interface without direct connection to the wireless cellular mobile telephone network; the system further including a client computer operatively attached to the wide area data network at a remote site outside the local region, wherein the client computer includes a subscriber identity module (SIM) reader, a method for providing telephone communications, the method comprising the steps of:
(a) providing the SIM reader with the SIM card inserted therein;
(b) transferring SIM authentication data of said SIM card to said terminal over the wide area data network;
(c) emulating said SIM card based on said SIM authentication data, said emulating performed by said emulator at the communications terminal; and
(d) providing said SIM authentication data to the wireless cellular mobile telephone network operator within the local region solely over the radio communications interface.

7. The method according claim 6, further comprising the step of:
(e) transferring said SIM authentication data between said client computer and said terminal, wherein said SIM authentication data is required for authenticating said SIM module by the local cellular mobile telephone operator.

8. The method according claim 6, further comprising the steps of:
(e) providing a server operatively attached to the wide area data network, said server including a SIM server and a session initiation protocol (SIP) server; and
(f) mediating said telephone communication between said client computer and said communications module of said communications terminal through the wide area data network, said mediating by said server.

9. The method according to claim 8, wherein said mediating includes initiation of said telephone communication, and after said initiation, bi-directional data streams of said telephone communication are transferred between said communications terminal and said client computer but not through said server.
